(19) United States
(12) Patent Application Publication
(10) Pub. No.: US 2006/0189260 A1
(43) Pub. Date: Aug. 24, 2006

(54) Process via worktable of relative coordinates

(76) Inventor: Kuo-Lung Sung, Pan Chiao City (TW)

Correspondence Address: LEONG C LEI, PMB # 1008, 1867 YGNACIO VALLEY ROAD, WALNUT CREEK, CA, 94598, US

(21) Appl. No.: 11/060,406

(22) Filed: Feb. 18, 2005

(51) Int. Cl. B24B 1/00; B26D 1/00

(52) U.S. Cl. 451/28; 83/13

(57) ABSTRACT

A process via a worktable of relative coordinates, which adopts relative coordinates to construct a processing worktable, and includes sliding rails of axes X, Y and Z. A main processing axle head, a cutter or the like is provided at axis Z, such that the axle head/cutter can travel along the processing path to cut a synchronically processing worktable, thereby proceeding to form a super precise size for thin objects. As the processing worktable is processed by an integral worktable of relative coordinates, the manufacture cost can be considerably reduced.

### BACKGROUND OF THE INVENTION

(a) Technical Field of the Invention

The present invention relates to a process via a worktable of relative coordinates, particularly to one applicable to super precise process and application of said worktable to process objects, which is remote from the process via conventional structure. The need of absolute parallel for worktables of big size is no longer sought for. In view of the novel process, the idea that only a worktable having an absolute level can process and cut a thin object that has a depth as preset in axis Z can be ruled out.

(b) Description of the Prior Art

When conventional processing equipment is used to perform high precision process on an object, particularly electronic and optical devices or components of high precision mold, etc., the manufacture process and design thereof usually adopt a worktable prepared with an absolute level, and then, based on the absolute level worktable, construct sliding rails of axes X, Y and Z, such that when the main processing axle head is moving in the three-dimensional space, it is strictly required that main processing axle head can retain an absolute level relative to the absolute level of the worktable, thereby the precision of the cutting process on super precision objects can be obtained.

As shown in FIG. 1, taking a conventional mold cutter 1 as an example, the mold cutter 1 is primarily provided with a worktable 50 which requires an absolute level. There are feet 11 under the peripheral bottom of the worktable 50, while pluralities of ventilating apertures 12 are provided at the worktable 50. Besides, sliding rails 20, 21 and 22 of axes X, Y and Z are provided at the edges of the worktable 50 with an absolute level. A main processing axle head 30 is provided at the sliding rail 22 of axis Z for installation of a cutter 31 for processing purpose. In the embodiment shown, the main processing axle head has been provided with a cutter, which can be alternatively be a sand wheel for grinding, a drill for drilling or a planer for planing, etc.

When super precision processing on a thin object is intended, the user should place the object on the worktable 50, turn on the vacuum extractor (not shown) such that an adsorption effect will occur on the ventilating apertures 12 to hold the thin object, drive the main processing axle head 30 via an NC data control program in order to process precise cutting on the surface of the thin object to obtain a precise depth. As the inaccuracy value allowable in the precise size process is minute, the concept carried by the above-mentioned conventional worktable includes the following points:
1. A processing worktable of an absolute level shall be constructed firstly.
2. Based on the absolute level worktable, sliding rails of axes X, Y and Z are provided to form a three-dimensional space.
3. After provision of the sliding rails of axes X, Y and Z, it is necessary and troublesome to carefully adjust the level (i.e. axes X and Y) and the verticality (i.e. axis Z) by filling padding.
4. The three-dimensional space constructed by axes X, Y and Z must be adjusted to accomplish an absolute level.

In view of the above, there exist in the conventional super precise processing worktable the following disadvantages:

a. When the size of the worktable is greater (above 1 m²), the difficulty and cost in obtaining an absolute level are higher.

b. After the sliding rails of axes X, Y and Z have been installed, it is time and cost consuming to adjust the level and verticality of each sliding rail in order to obtain an absolute level worktable.

Accordingly, while the conventional worktable of an absolute level is utilized to produce a processing mechanism, the cost would reach more than US$350,000, wherein around 80% of the cost is spent in the adjustment process.

In view of the above, the inventor intended to avoid the disadvantages existent in the prior art, and wished to provide a new concept that utilizes relative coordinates value to construct a processing worktable easily manufactured and low-priced, such that thin objects can be easily processed in cutting, grinding or drilling to obtain an equal depth at the processed thin object and accomplish a preferred processing design without being affected by the environments, thereby improving the inconvenience in the prior art.

### SUMMARY OF THE INVENTION

The primary purpose of the present invention is to provide a process via a work table of relative coordinates, which changes the idea that only a worktable having an absolute level can process to cut a thin object that has a depth as preset in axis Z, and can relatively reduce the manufacture cost.

The secondary object of the invention is to provide a process via a worktable of relative coordinates, which can easily construct a process worktable for proceeding cutting or grinding on the thin objects having processed grooves of the same depth.

A further object of the invention is to provide a process via a worktable of relative coordinates, in which relative coordinates and synchronal plane are adopted, such that a synchronal plane will be formed by the tracks processed by the main processing axle head at axis Z forwarding along axes X and Y, thereby a worktable applicable for processing thin objects can be easily and instantly constructed.

Yet a further object of the invention is to provide a process via a worktable of relative coordinates, which can process thin objects via the constructed plane, thereby considerably reduce the manufacture cost.

To obtain the above objects, the process via a worktable of relative coordinates according to the invention focuses on the idea of relative coordinates, so that a processing worktable is provided with a track/path formed by the main processing axle head at axis Z forwarding along axes X and Y. Given the synchronal plane, any thin object adsorbed on the worktable can be easily processed to form grooves of an equal depth.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional worktable adopting absolute parallel.

FIG. 2 is an exploded view of the base of the worktable according to the present invention.

FIG. 3 shows processing with cutting via the base of the worktable according to the present invention.

FIG. 4 is a cut-away view of the base of the worktable, showing the cutting process.

FIG. 5 is a cut-away view of the base of the worktable after the cutting process.

FIG. 6 shows application of the invention to process a thin object which is disposed on the worktable.

FIG. 7 shows adsorption of the thin object to the worktable via vacuum for holding purpose.

FIG. 8 is a cut-away view of the cut object.

FIG. 9 is a further cut-away view of the cut object.

FIG. 10 is a side view of the cut thin object.

FIG. 11 shows the cut thin object being leveled.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

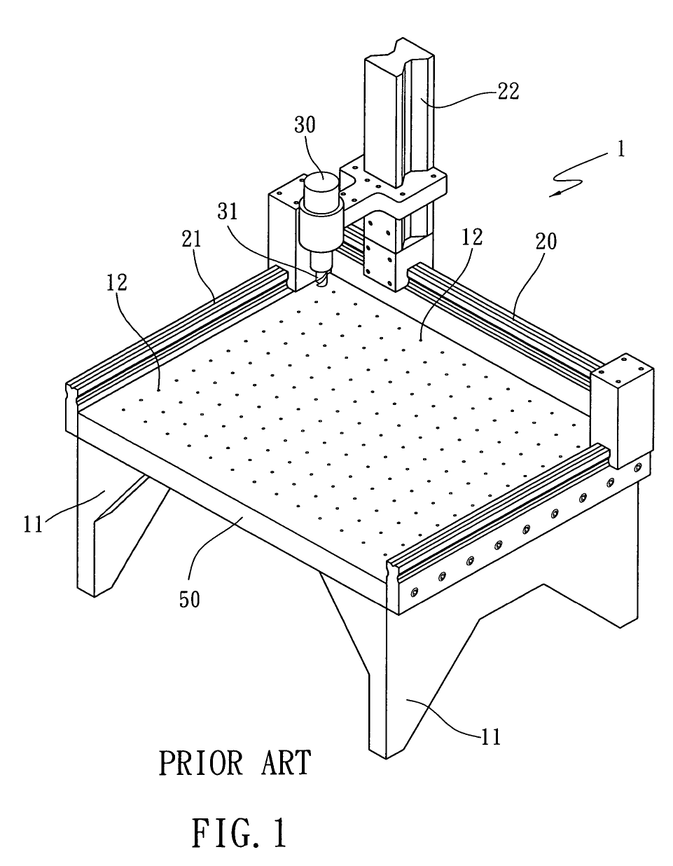

FIG. 1 shows a conventional worktable adopting absolute theory, the detailed structure has been portrayed.

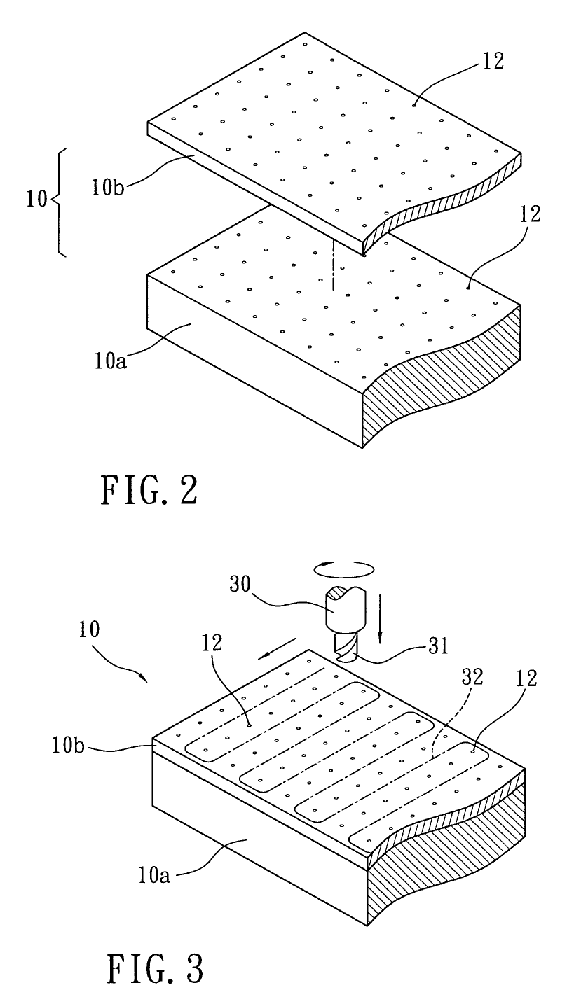

Referring to FIG. 2, in “a process via a worktable of relative coordinates” according to the invention, a rigid metal board is selected to serve as a base 10a, above which is provided with a process board 10b. The process board 10b is combined with the base 10a via an electric welding equipment or alternatively via fasteners from the bottom to the top going though the base 10a, such that the base 10a and the process board 10b can be integrally combined together. The base 10a and the process board 10b are provided with coinciding ventilating apertures 12 which is connected with additionally provided vacuum equipment. The process board 10b can be a relatively thin metal board or a bakelite.

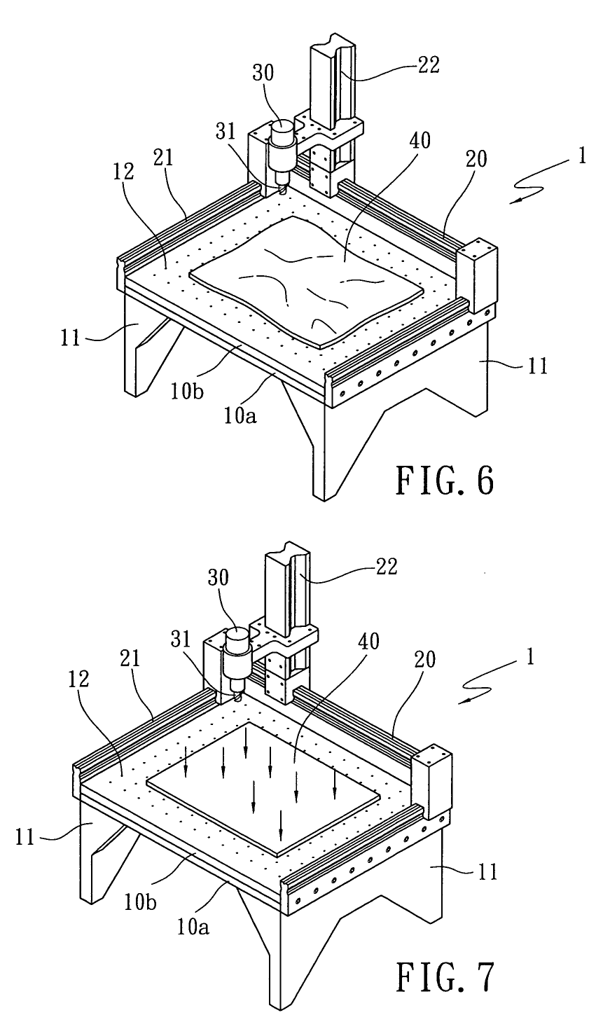

After the base 10a and the process board 10b are integrally combined together to form a worktable 10, the sliding rails 20, 21 and 22 respectively moving on axes X, Y and Z are mounted along the edges of the worktable 10 (as shown in FIGS. 6 and 7). The sliding rails of axes X, Y and Z form a right angle to one another; alternatively, axes X and Y can be out of right angle. An NC data control program is applied to make axis Z to go down to a certain height, such that the cutter 31 along with the main processing axle head 30 will process with cutting. The tracks 32 on the processable board 10a processed by the cutter 31 must be arranged all over the whole surface of the processable board 10a, thereby a relative coordinates corresponding to the three-dimensional space formed by axes X, Y and Z will be accomplished.

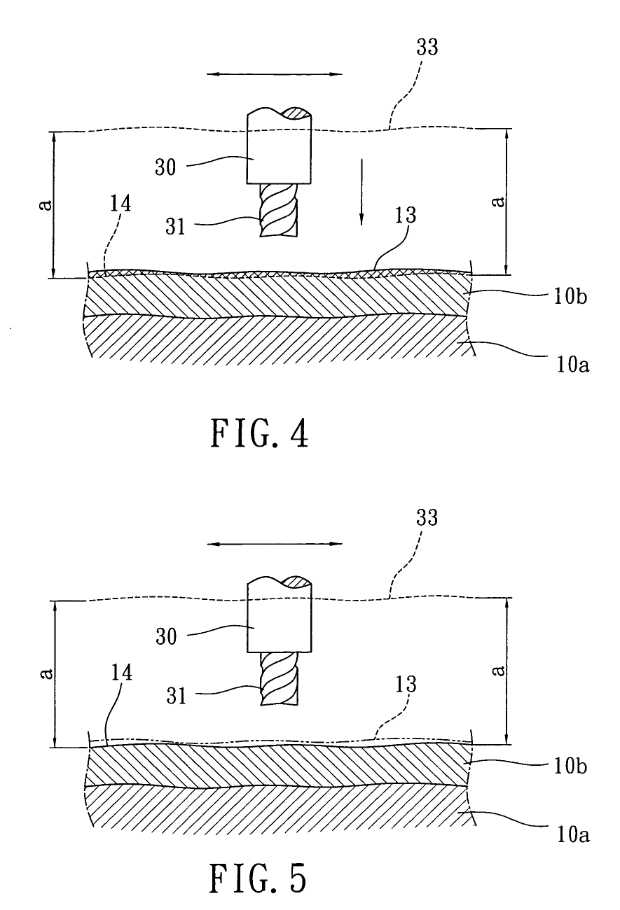

FIG. 4 is a cut-away view showing the worktable 10 in an enlarged status. As shown, the processable board 10b is stacked above the base 10a, while the surface of the processable board 10b has a seeming level with a lumpy surface 13. The virtual reality standard level 33 shown is a level with a certain height a that the cutter 31 of the processing main axle 30 goes by axes X and Y. While the sliding rails 20, 21 & 22 of axes X, Y and Z have been readily set, the virtual realty standard level 33 and the lumpy surface 31 are not absolutely parallel to each other.

As shown in FIG. 5, the main processing axle head 30 along with the cutter 31 is lowered down, such that the cutter 31 will be able to proceed cutting on the lumpy surface 13 to form a synchronal plane. The lumpy surface 13 exactly matches the virtual reality standard level 33, i.e. the tracked surface formed by the movement of the main processing axle head 30 on axes X, Y and Z. Accordingly, any position on the synchronal plane of the processable board 10b will have an equal depth that is identical to the height set on the processing axis Z, thereby the synchronal plane can be applied to process thin objects.

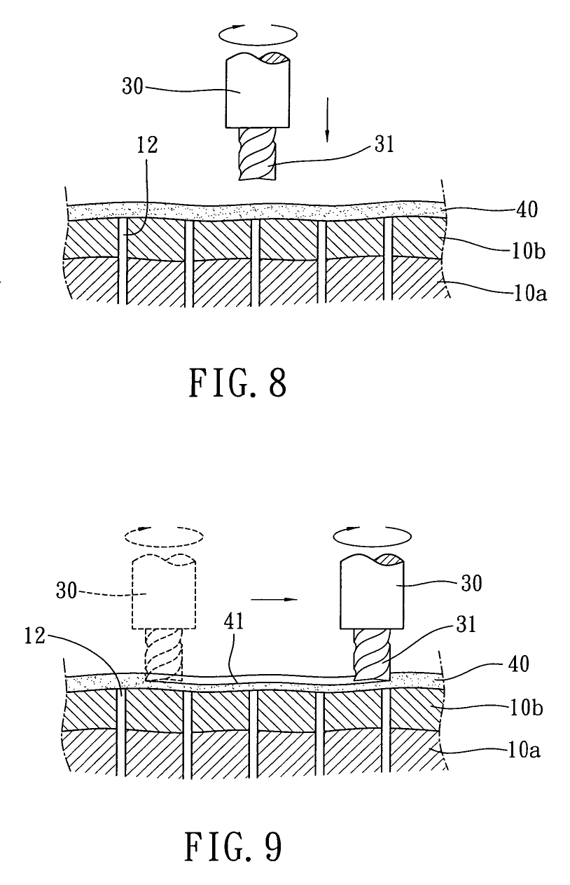

As shown in FIGS. 6 to 8, the invention adopts the synchronal plane worktable 10 to construct the tracks formed by the relative movement of the main processing axle head 30 and axes X, Y and Z. To process cutting on a thin object 40 to form grooves 41 of an equal depth (as shown in FIG. 11), the processing steps include: disposing the thin object 40 to be processed on the processing worktable 10; turning on the vacuum extractor (not shown) such that the ventilating apertures 12 will adsorb and hold the thin object 40 on the lumpy surface 14 of the processing worktable 10 (as shown in FIG. 7); and driving the main processing axle head 30 by the NC data control program to process cutting on the surface of the thing object 40 to form a precise depth. Referring to FIG. 9, when the main processing axle head 30 is lowered from the position shown in FIG. 8, such that the cutter 31 may proceed with cutting on the thin object 40 and move to direction toward axes X and Y, thereby a groove 41 of an equal depth from end to end can be formed.

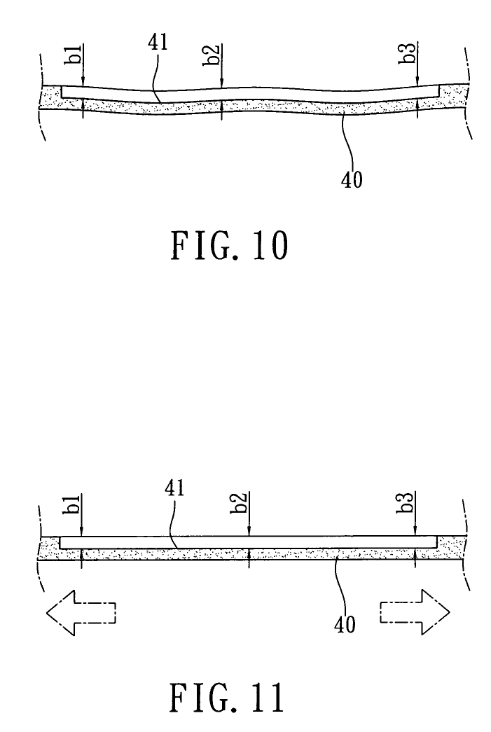

Referring to FIGS. 10 and 11, after a synchronal plane has been constructed on the lumpy surface 14 via synchronal coordinates value, the synchronal plane worktable can be applied to process thin objects 40. As inaccuracy allowable in the relevant industries of the precise size processing is minute, after the thin object 40 is cut to form a groove 41 as shown in FIG. 10, the thin object 40 can be taken off of the processing worktable 10 and then leveled evenly. Accordingly, the groove 41 will have an equal depth in positions b1, b2 and b3.

Concluded above, the process via a worktable of relative coordinates according to the invention can ease the construction of a worktable to efficiently process cutting, drilling or the like on thin objects. Besides, providing the worktable of the invention can be instantly and efficiently without the limitation of absolute level required in the prior art, thereby the total manufacture cost can be considerably reduced, and the commercial competitiveness can be greatly enhanced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A process via a worktable of relative coordinates, characterized in that:
a board material is utilized as a base which is provided with a processable board combined thereon, sliding rails having axes X, Y and Z at the edges of the base to form a 3-dimentional space; a main processing axle head is provided at axis Z, such that the axle head can fix with a processing device to axis Z at a predetermined height for proceeding with cutting or grinding on the surface of the processable board; the main processing axle head has a path traveling overall the surface of the processable board, thereby constructing a virtual reality synchronal platform which matches the processing track formed by axes X, Y and Z, and accordingly allowing all positions on the surface of the processable board have the same height as that preset on axis Z for the purposes of processing thin objects.

2. The process via a worktable of relative coordinates according to claim 1, wherein the base is a metal board.

3. The process via a worktable of relative coordinates according to claim 1, wherein the process board can be a relative thin metal board.

4. The process via a worktable of relative coordinates according to claim 1, wherein the process board can be a bakelite board.

5. The process via a worktable of relative coordinates according to claim 1, wherein the sliding rails of axes X, Y and Z assume a 90° right angle to each other.

6. The process via a worktable of relative coordinates according to claim 1, wherein the processing device held by the main processing axle head is provided with a rotating power for proceeding with cutting via a milling cutter, grinding via a sand wheel or drilling via a drill.

7. The process via a worktable of relative coordinates according to claim 1, wherein the process board is connected to the metal base via welding.

8. The process via a worktable of relative coordinates according to claim 1, wherein the process board is connected to the metal base via fasteners.
